(19) United States
(12) Patent Application Publication
(10) Pub. No.: US 2015/0211446 A1
(43) Pub. Date: Jul. 30, 2015

(54) VEHICLE FUEL SUPPLY SYSTEM

(71) Applicant: Bennett Autogas Systems, LLC, Minneapolis, MN (US)

(72) Inventor: David Edward Bennett, Minnepolis, MN (US)

(21) Appl. No.: 14/600,444

(22) Filed: Jan. 20, 2015

Related U.S. Application Data
(60) Provisional application No. 61/931,273, filed on Jan. 24, 2014.

(51) Int. Cl. F02M 21/02; F02M 69/46

(52) U.S. Cl. CPC F02M 21/0212; F02M 69/462

(57) ABSTRACT

A fuel supply system for supplying a low boiling point fuel to an internal combustion engine of a vehicle includes a fuel tank that encloses a tank volume and includes a primary chamber within the tank volume, a head chamber within the tank volume, and a divider wall. The head chamber is configured to contain fuel up to a head height. The divider wall is attached to a wall of the fuel tank and separates the primary chamber and the head chamber. A fluid pathway guides fuel from along a floor of the tank in the primary chamber through the divider wall and into the head chamber at or above the head height, responsive to movement of the fuel in the primary chamber. An output port is located in a wall of the head chamber adjacent the floor.

### FIELD

Embodiments of the invention generally relate to vehicle fuel supply systems including, for example, vehicle fuel supply systems configured to deliver liquefied petroleum gas (LPG) to a combustion engine.

### BACKGROUND

LPG or Autogas is a common low boiling point fuel that includes a combination of propane and butane. It is desirable to use LPG in combustion engines due to its high octane rating and energy content, and low carbon dioxide exhaust emissions.

LPG and other low boiling point fuels must be maintained under pressure at temperatures above their boiling points to maintain the fuels in their liquid state. Examples of low boiling point liquids and fuels are propane (−42F), propylene (−54F), butane (−5F), dimethyl-ether (−5F), and ammonia (−28F). FIG. 1 shows the boiling point versus pressure curves for propane and butane. These curves are the pressures in the tank for each temperature of the liquid contents.

Autogas tanks for motor vehicles are typically fabricated by welding together steel stampings: the round shell and the end domes. Along with mounting and lifting brackets, fittings for outlet valves, fill valves, and level and pressure sensors are welded to the wall or end domes, as specified by the vehicle manufacturer. The manufacturer is required to pressure test each tank at five times the pressure relief valve setting, which is typically 22 Mpa or 312 psi, or 110 MPa or 1760 psi.

The advent of electronic fuel injection of LPG in the 1990′s brought with it the need to pressurize the fuel system to avoid vaporization prior to injection. However, withdrawing a saturated liquid from a tank with any level of pump suction, even from slightly below the pressure shown in FIG. 1, would vaporize the fuel resulting in vaporlock, which prevents the pump from pressurizing and driving a flow of the fuel into the engine. Attempts at pressurizing propane after withdrawing it from the tank for fuel injection were unsuccessful because too much suction caused vaporization at the pump inlet and, thus, vaporlock.

U.S. Pat. No. 5,291,869, which issued to David Bennett, utilized an in-tank gasoline pump to form a liquid injection propane electronic fuel injection (LPEFI) tank. A schematic diagram of an in-tank LPG fuel injection system is provided in FIG. 2. Gasoline pumps also have limited vacuum lift capabilities, especially in hot weather, which assists in avoiding vaporlock.

One technique that has been used to reduce the likelihood of vaporlock, is to place the pump in a short vertical tube that is welded to the bottom of the tank in accordance with gasoline fuel injection practice. This provides the inlet of the pump with a vertical head of fuel due (e.g., 1 inch) to wave action filling the tube. However, in most truck applications, where the bottom of the tank is exposed to the road and associated flying road trash, pump placement to achieve a positive inlet head is especially problematical, as the pump cannot be positioned below the tank.

In-tank fuel injection pumps tend to require frequent servicing due to the propane and the type of pumps that are used. Propane fuel is typically contaminated with particles that resist filtration using the best commercially available autogas filters, which are rated at 3.0 microns and a 99.8% capture rate. These contaminants may adversely affect the operation of in-tank pumps.

Also, most in-tank pumps, both gasoline and propane, have brush-type motors, which are submerged in the fuel. These factors cause in-tank pumps to wear and eventually fail.

When in-tank fuel injection pumps fail, all of the autogas in the tank must be removed before accessing the pump. The removal of the low boiling point fuel involves releasing a significant amount of fuel vapor into the atmosphere, unless an expensive capturing system is used. The process needs to be done outside, away from other vehicles and buildings. Typically 20 to 40 gallons needs to be removed, a process can take over two hours, and it must be watched by the technician. Grounding the tank to avoid static electricity discharge when servicing the open tank is mandatory.

### SUMMARY

Embodiments of the invention are directed to fuel supply systems for supplying a low boiling point fuel to an internal combustion engine of a vehicle, and methods of supplying a low boiling point fuel to an internal combustion engine of a vehicle using the system. Some embodiments of the system include a fuel tank that encloses a tank volume and includes a primary chamber within the tank volume, a head chamber within the tank volume, and a divider wall. The head chamber is configured to contain fuel up to a head height. The divider wall is attached to a wall of the fuel tank and separates the primary chamber and the head chamber. A fluid pathway guides fuel from along a floor of the tank in the primary chamber through the divider wall and into the head chamber at or above the head height, responsive to movement of the fuel in the primary chamber. An output port is located in a wall of the head chamber adjacent the floor.

In some embodiments of the method, a fuel tank is mounted on a mobile vehicle. The fuel tank encloses a tank volume and includes a primary chamber within the tank volume, a head chamber within the tank volume that is configured to contain fuel up to a head height, and a divider wall that is attached to a wall of the fuel tank and separates the primary chamber and the head chamber. In the method, fuel is guided from along a floor of the tank in the primary chamber and into the head chamber through a fluid pathway responsive to movement of the mobile vehicle. The fuel is pumped from the head chamber through an output port and to the internal combustion engine using a pump that is located externally to the tank volume.

### BRIEF DESCRIPTION OF THE DRAWINGS

FIG. 1 is a chart illustrating saturation pressure versus fuel temperature for propane and butane.

FIG. 2 is a schematic illustration of a LPEFI tank in accordance with the prior art.

FIG. 3 is a simplified diagram of a fuel supply system in accordance with embodiments of the invention.

FIG. 4 is a simplified isometric view of a divider wall in accordance with embodiments of the invention.

FIG. 5 is a simplified top view of a mobile vehicle illustrating tank mounting options in accordance with embodiments of the invention.

FIGS. 6A-B are simplified side cross-sectional views of a fuel tank of a fuel supply system in accordance with embodiments of the invention.

FIG. 7 is a simplified cross-sectional view of the fuel tank of FIG. 6A taken generally along line 7-7.

FIG. 8 is a simplified side view of a portion of a fuel tank in accordance with embodiments of the invention.

FIGS. 9 and 10 are simplified top views of a portion of the fuel tank in accordance with embodiments of the invention.

FIGS. 11A-B are simplified side cross-sectional views of a fuel tank of a fuel supply system in accordance with embodiments of the invention.

FIGS. 12-15 respectively are front, back, side and side cross-sectional views of a divider wall and fluid pathway in accordance with embodiments of the invention.

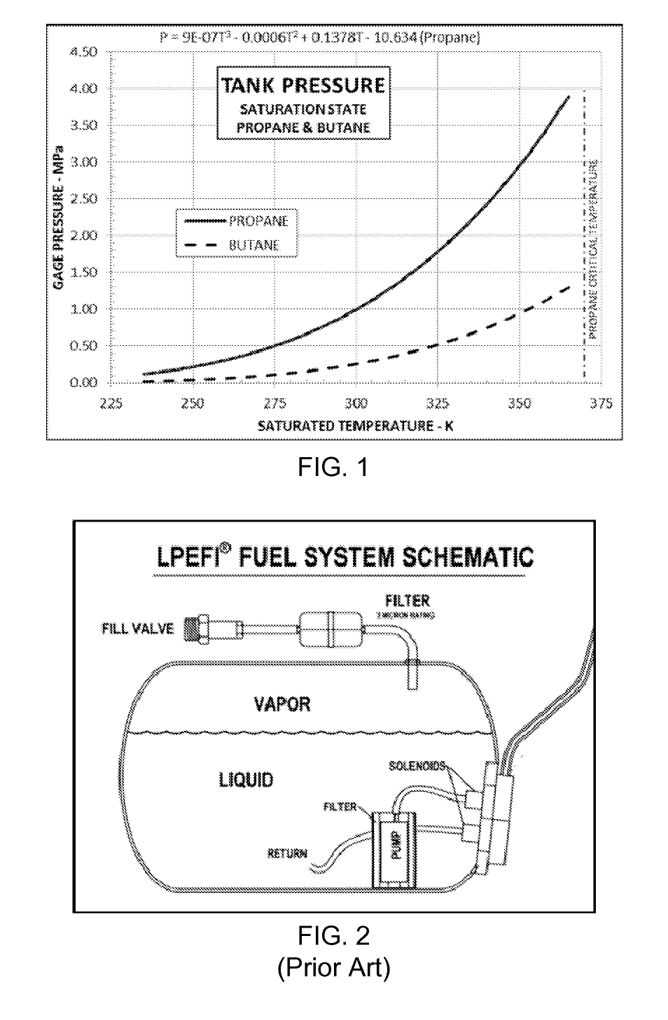

### DETAILED DESCRIPTION OF ILLUSTRATIVE EMBODIMENTS

Embodiments of the invention are described more fully hereinafter with reference to the accompanying drawings. Elements that are identified using the same or similar reference characters refer to the same or similar elements. The various embodiments of the invention may, however, be embodied in many different forms and should not be construed as limited to the embodiments set forth herein. Rather, these embodiments are provided so that this disclosure will be thorough and complete, and will fully convey the scope of the invention to those skilled in the art.

Specific details are given in the following description to provide a thorough understanding of the embodiments. However, it is understood by those of ordinary skill in the art that the embodiments may be practiced without these specific details. For example, circuits, systems, networks, processes, frames, supports, connectors, motors, processors, and other components may not be shown, or shown in block diagram form in order to not obscure the embodiments in unnecessary detail.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element is referred to as being “connected” or “coupled” to another element, it can be directly connected or coupled to the other element or intervening elements may be present. In contrast, if an element is referred to as being “directly connected” or “directly coupled” to another element, there are no intervening elements present.

It will be understood that, although the terms first, second, etc. may be used herein to describe various elements, these elements should not be limited by these terms. These terms are only used to distinguish one element from another. Thus, a first element could be termed a second element without departing from the teachings of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Embodiments of the invention may also be described using flowchart illustrations and block diagrams. Although a flowchart may describe the operations as a sequential process, many of the operations can be performed in parallel or concurrently. In addition, the order of the operations may be re-arranged. A process is terminated when its operations are completed, but could have additional steps not included in a figure or described herein.

It is understood that one or more of the blocks (of the flowcharts and block diagrams) may be implemented by computer program instructions. These program instructions may be provided to a processor circuit, such as a microprocessor, microcontroller or other processor, which executes the instructions to implement the functions specified in the block or blocks through a series of operational steps to be performed by the processor(s) and corresponding hardware components.

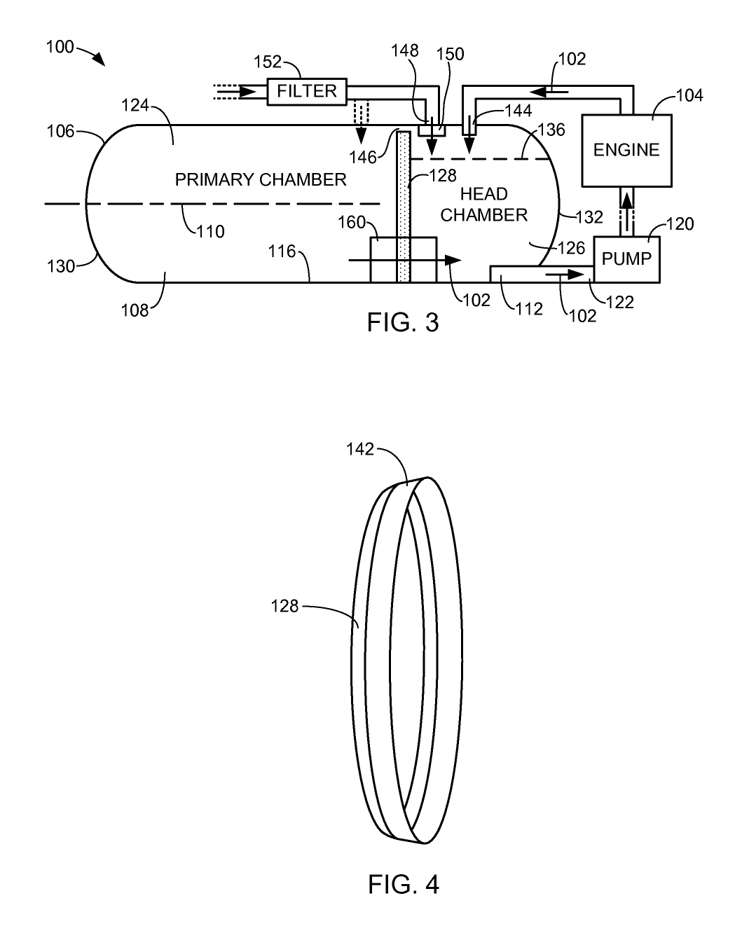

FIG. 3 is a simplified diagram of a fuel supply system 100 in accordance with embodiments of the invention. In some embodiments, the fuel supply system 100 is configured to supply fuel 102 to an internal combustion engine 104 through, for example, a liquid fuel injection system (not shown). In some embodiments, the fuel 102 is a low boiling point fuel, such as liquid propane, liquid butane, liquefied petroleum (LPG), or other low boiling point fuel. In some embodiments, the system 100 is configured to be mounted to a mobile vehicle and to supply fuel to the engine 104 of the mobile vehicle.

In some embodiments, the system 100 includes a fuel tank 106 that encloses a tank volume 108. In some embodiments, the tank 106 has an elongate shape and a longitudinal axis 110, as shown in FIG. 3.

In some embodiments, an output port 112 extends through a wall 132 of the fuel tank 106 adjacent a floor 116 of the tank 106. In some embodiments, the output port 112 includes a manual or solenoid actuated shutoff valve (not shown). In some embodiments, the shutoff valve is a conventional valve that includes a built-in excess flow valve per the NFPA 58 requirements. In the event of a major leakage or line failure in the fuel injection system, the excess flow valve will self-close. The excess flow valve is designed to function even when the manual shut off valve is sheared off in an accident.

In some embodiments, the system 100 does not include an electric pump within the tank 106 or tank volume 108. Rather, in some embodiments, the system 100 utilizes an electric pump 120 that is located externally to the tank 106, as shown in FIG. 3. One advantage to this configuration is that it simplifies servicing the pump, as compared to in-tank pumps of fuel supply systems of the prior art. In particular, the system 100 can service the pump 120 without draining the tank 106 of fuel. Additionally, the number of critical sealing surfaces and joints on the tank 106 is reduced, which lowers tank cost and post-service safety risks. In some embodiments, the fuel pump 120 includes an integral filter and a sealed housing that accommodate ease of service and rebuilding.

In some embodiments, the system 100 is configured to provide a consistent and deep fluid pressure at an inlet 122 to the external pump 120 to avoid vaporlock in the pump 120. In some embodiments, the tank volume 108 encloses a primary chamber 124 and a head chamber 126, from which the fuel 102 is delivered to the inlet 122. A divider wall 128, located between end walls 130 and 132 of the tank 106, separates the primary chamber 124 from the head chamber 126. In some embodiments, the divider wall 128 is located closer to the end 132 than the end 130 making the primary chamber 124 larger than the head chamber 126. In some embodiments the volume of the head chamber 126 is approximately 5-20% of the volume of the primary chamber 124.

In some embodiments, the divider wall 128 is attached to an interior wall of the tank 106. In some embodiments, a seal is formed between the divider wall 128 and the interior wall of the fuel tank 106 up to at least a head height 136, to which the head chamber 126 can be filled.

FIG. 4 is a simplified isometric view of the divider wall 128 in accordance with embodiments of the invention. In some embodiments, the divider wall 128 includes a circumferential flange 142 that is preferably angled 5-15 degrees from perpendicular. In some embodiments, the flange 142 is sufficiently flexible to conform to any out-of-round condition inside the tank 106. In some embodiments, the flange 142 creates an interference with the interior wall of the tank 106 to enable easier positioning of the divider wall 128 within the tank 106. The flange 142 also reduces stresses on the weld between the divider wall 128 and the interior wall of the tank 106 caused by the expansion and contraction of the tank 106 due to temperature changes and changes in pressure within the tank volume 108.

The pump 120 draws fuel 102 from within the head chamber 126 through the port 112 and the inlet 122, as indicated in FIG. 3. The pump 120 drives the fuel 102 to a liquid fuel injection system (not shown) of the engine 104. In some embodiments, a filter may be positioned downstream of the port 112 or the inlet 122, and upstream of the engine 104 to protect the fuel injectors from contaminants.

In some embodiments, fuel 102 that is not delivered for combustion by the fuel injection system is returned to the tank 106, through a return port 144, as shown in FIG. 3. In some embodiments, the return port 144 is positioned to discharge the returning fuel 102 into the head chamber 126 above the head height 136. This reduces the need for fuel transfer between the chambers 124 and 126 during engine warm-up. In some embodiments, the return fuel 102 from the fuel injection system is passed through a conventional “back-check” or one-way valve.

When the engine 104 is fully warmed, some or all of the returning fuel 102 may be vaporous. The vaporized returning fuel 102 increases the pressure in the tank 106 because it cannot be immediately condensed. In some embodiments, an opening 146 is provided between the divider wall 128 and the ceiling of the fuel tank 106, to balance the pressure between the primary chamber 124 and the head chamber 126 and prevent choking of the fluid transfer through the fluid pathway 160 in response to the return of fuel 102 from the fuel injection system. In some embodiments, the opening 146 is formed by deflecting or notching the flange 142 at the twelve o'clock position.

In some embodiments, the system 100 includes a fill port 148, through which fuel may be delivered into the tank 106. In some embodiments, the fill port 148 is configured to discharge fill fuel into the head chamber 126, or the primary chamber 124, as shown in phantom lines. One advantage to configuring the fill port 148 to fill the head chamber 126 is that it allows for a relatively small amount of fuel to be added to the tank 106 to provide a sufficient volume of fuel 102 within the head chamber 126 to allow the engine 104 to operate. When the fill port 148 is located such that fill fuel is discharged into the primary chamber 124, a small bleed hole may be provided in the divider wall 128 slightly below a full level for the primary chamber 124 to ensure that fuel 102 is delivered into the head chamber 126.

In some embodiments, the system 100 includes a stop-fill mechanism or valve 150 that is coupled to the fill port 148 and is configured to prevent overfilling the tank volume 108. In some embodiments, the stop-fill mechanism or valve 150 is configured to limit the filling of the fuel tank 106 to a full level that is above the head height 136. In some embodiments, a filter 152 (e.g., a 3 micron-rated filter) is positioned upstream of the fill port 148 to limit particle introduction into the tank 106.

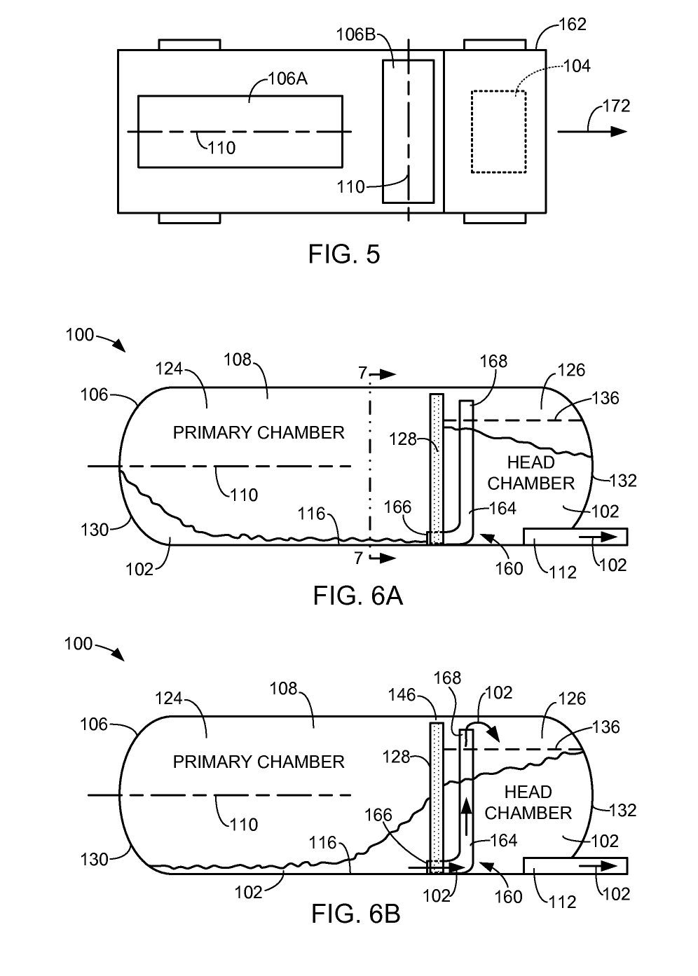

In some embodiments, the system 100 includes a fluid pathway 160 through which the fuel 102 is transferred from the primary chamber 124 to the head chamber 126 responsive to movement of the fuel 102 within the tank 106. In some embodiments, the tank 106 is mounted to a mobile vehicle 162, as shown in the simplified top view of FIG. 5. During normal operation of the mobile vehicle 162, the tank 106 undergoes periods of acceleration and deceleration, which drives movement of the fuel 102 within the primary chamber 124 such that the fuel 102 is driven through the fluid pathway 160 and into the head chamber 126, as indicated in FIG. 3. Even small variations in speed (less than 0.05 g's) can cause the fuel 102 to be driven through the fluid pathway 160 due to the low density of liquid propane and butane. This process fills the head chamber 126 with the fuel 102 and ensures a consistent fluid pressure at the inlet 122 to the pump 120 even when the depth of the fuel 102 in the primary chamber 124 is close to zero.

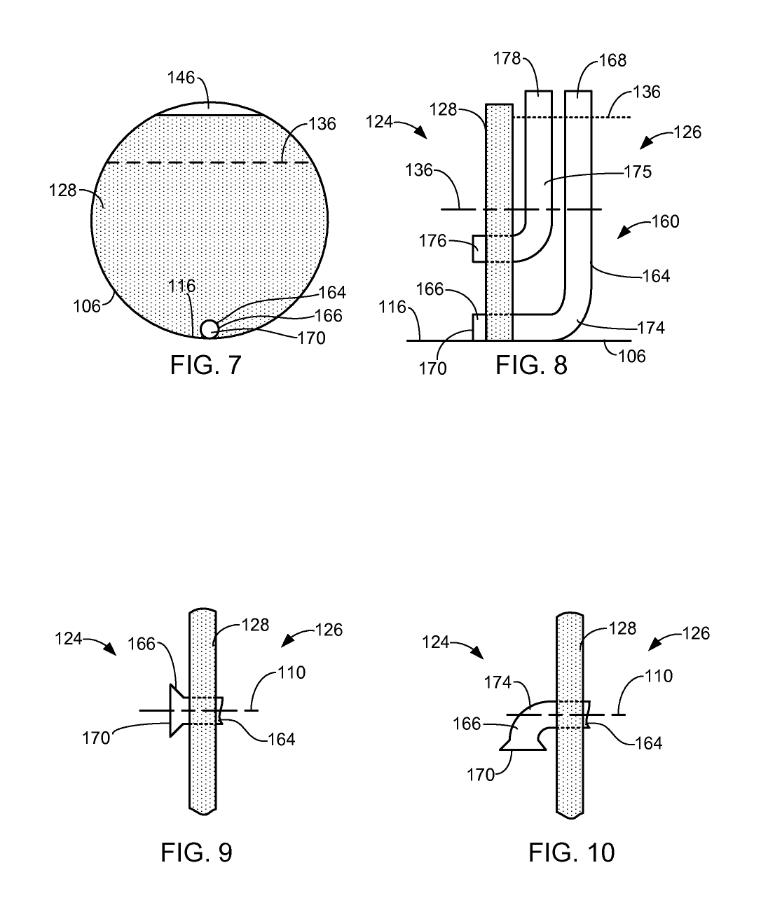

In some embodiments, the fluid pathway 160 comprises a tube 164 through which fuel 102 can travel from the primary chamber 124 to the head chamber 126, as shown in FIGS. 6A-B, which are simplified side views of a fuel tank 106 of the system 100 in accordance with embodiments of the invention. FIG. 7 is a simplified cross-sectional view of the tank 106 of FIG. 6A taken generally along line 7-7. FIG. 8 is a simplified side view of a portion of the tank 106 in accordance with embodiments of the invention. The return port 144, fill port 148 and other elements are not shown in order to simplify the illustrations.

In some embodiments, the tube 164 includes an end 166 that is connected to and/or extends through the divider wall 128 adjacent the floor 116 of the tank 106 (FIGS. 6A-B, 7 and 8), and an end 168 located within the head chamber 126 at or above the head height 136, as shown in FIGS. 6 and 8. In some embodiments, a seal is formed between the end 166 of the tube 164 and the divider wall 128.

In some embodiments, the end 166 of the tube 164 includes an opening 170 that may be flared to capture fuel 102 sloshing within the primary chamber 124, as shown in FIGS. 9 and 10, which are simplified top views of a portion of the fuel tank 106 in accordance with embodiments of the invention. In some embodiments, the end 166 of the tube 164 is located slightly above the floor 116 of the tank 106 (e.g., approximately ½ inch) to allow for the accumulation of particles along the floor 116 while avoiding transferring the particles into the head chamber 126.

In some embodiments, the opening 170 of the tube 164 is oriented in the direction of the longitudinal axis 110 of the tank 106, as shown in FIGS. 8 and 9. This embodiment of the tank 106 is best suited for being mounted on a mobile vehicle 162 with the longitudinal axis 110 oriented generally parallel to a forward direction of travel 172 of the vehicle 162, such as tank 106A shown in the simplified top view of the mobile vehicle 162 provided in FIG. 5. This orientation of the tank 106A will subject the fuel 102 to accelerations and decelerations along the longitudinal axis 110 of the tank 106A in response to the acceleration and deceleration of the mobile vehicle 162. Thus, the fuel 102 within the primary chamber 124 will move toward an end 130 of the primary chamber 124, as illustrated in FIG. 6A, and then move back toward the end 132 and head chamber 126 of the tank 106, as illustrated in FIG. 6B, in response to movement of the tank 106 or movement of a vehicle 162 to which the tank 106 is mounted. This motion of the fuel 102 drives the fuel 102 into the opening 170 at the end 166 of the tube 164, through the tube 164, and out the end 168 within the head chamber 126, as illustrated in FIG. 6B. This fills the head chamber 126 with a sufficient volume of fuel 102 to maintain a desired pressure at the inlet 122 to the pump 120.

In some embodiments, the opening 170 of the tube 164 is oriented in a direction that is perpendicular or transverse to the tank longitudinal axis 110, as shown in FIG. 10. In accordance with this embodiment, the opening 170 is configured to capture fuel 102 moving transversely to the longitudinal axis 110 within the tank 106. Thus, this embodiment of the fluid pathway 160 may be best suited for a tank 106 that is mounted to the mobile vehicle 162 with the longitudinal axis 110 oriented transversely to the direction of travel 172, as indicated by tank 106B in FIG. 5.

In some embodiments, the tube 164 includes at least one bend 174. In some embodiments, at least one of the bends 174 is oriented in a vertical plane, such as shown in FIG. 9, to direct the end 168 of the tube 164 vertically. In some embodiments, at least one of the bends 174 is oriented in a horizontal plane, such as shown in the top view of FIG. 10.

In some embodiments, the fluid pathway includes a second tube 175 having an end 176 and an end 178. The end 176 of the tube 175 is attached to the divider wall 128 above the end 166 of the tube 164, as shown in FIG. 8. The tube 175 operates to provide an additional pathway for fuel 102 to travel from the primary chamber 124 to the head chamber 126.

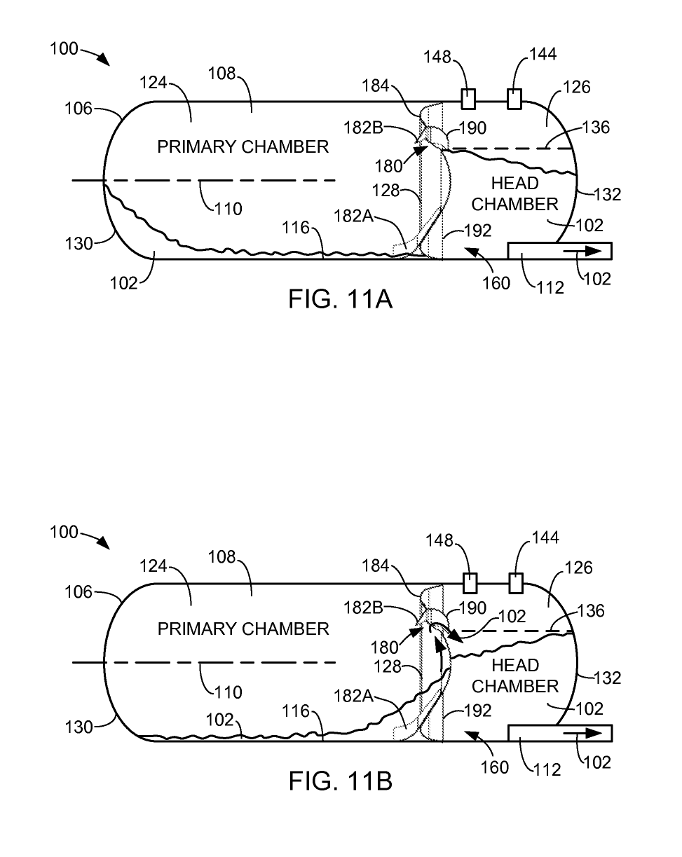

FIGS. 11A-B are simplified side cross-sectional views of a fuel tank 106 of a fuel supply system 100 illustrating a fluid pathway 160 in accordance with embodiments of the invention. Some elements of the system 100 are not shown in order to simplify the drawings. In some embodiments, the fluid pathway 160 is formed by providing an opening 180 in the divider wall 128 that is at or above the head height 136, as shown in FIGS. 11A-B. In some embodiments, the tank 106 does not include the opening 146 (FIG. 7) between an upper edge of the divider wall 128 and the interior tank wall due to the opening 180. As discussed above, the fuel 102 within the primary chamber 124 sloshes toward the end wall 130, as illustrated in FIG. 11A, and then moves toward the divider wall 128, as illustrated in FIG. 11B, responsive to movement of the vehicle 162 (FIG. 5) to which the tank 106 is mounted. In some embodiments, the fluid pathway 160 comprises one or more fuel guides, generally referred to as 182, that direct the fuel 102 through the opening 180 as the fuel 102 moves from the end wall 130 against the divider wall 128, as shown in FIG. 11B.

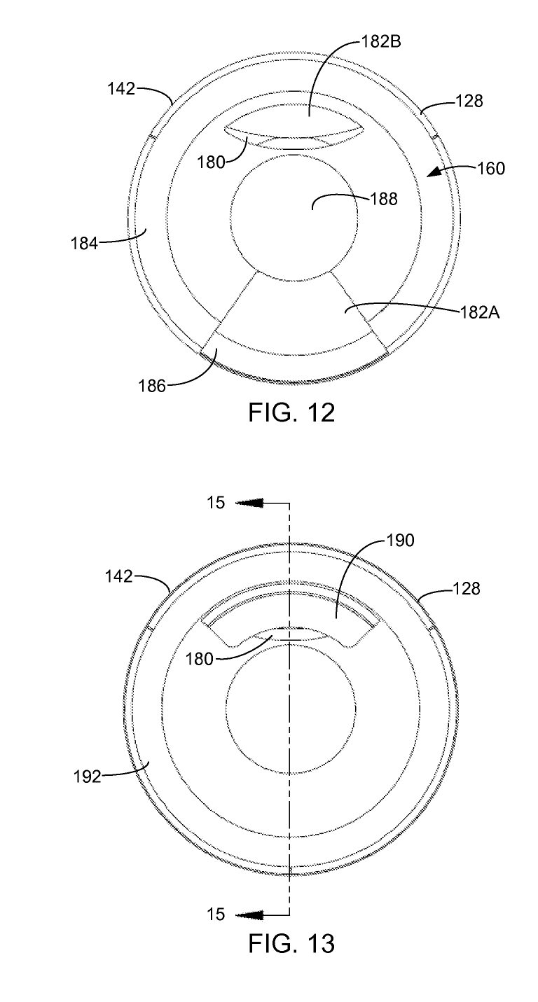

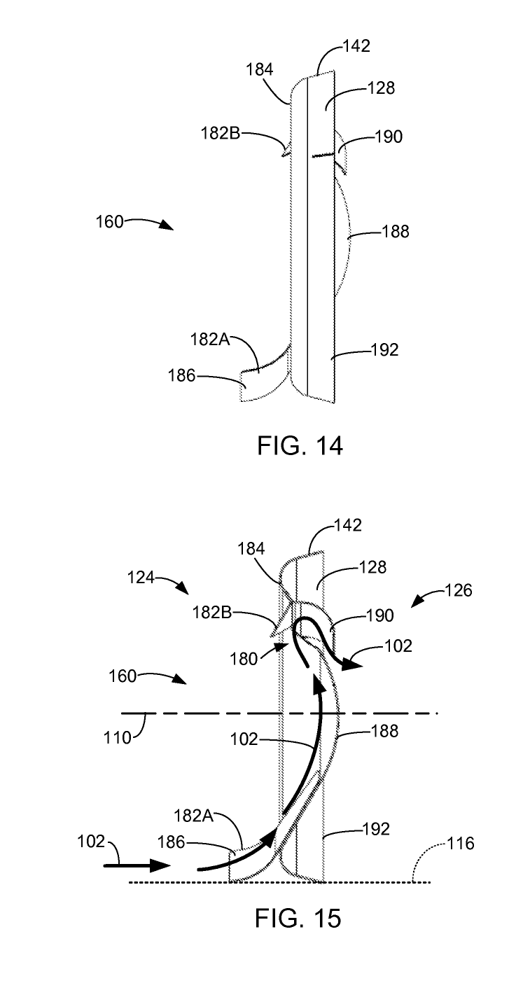

FIGS. 12-14 are front, back, and side views of a divider wall 128 and fluid pathway 160 having fuel guides 182, in accordance with embodiments of the invention. FIG. 15 is a side cross-sectional view of the divider wall 128 of FIG. 13 taken generally along line 15-15. In some embodiments, the guides 182 include a lower guide 182A, which directs the fuel 102 on a front side 184 of the divider wall 128, which faces the primary chamber 124, upward from the floor 116 toward the opening 180. In some embodiments, the lower guide 182 includes a bottom portion 186 that projects toward the floor 116. In some embodiments, the bottom portion 186 is a separate component that is attached (e.g., welded, adhered, etc.) to the front side 184 of the divider wall 128. In some embodiments, the lower guide 182A or a central portion 188 of the divider wall 128, has a convex shape that transitions movement of the fuel 102 along the axis 110 upward toward the opening 180.

In some embodiments, the fuel guides 182 include an upper guide 182B, which captures the fuel 102 traveling up the divider wall 128 or lower guide 182A, and directs the captured fuel 102 into the head chamber 126, as shown in FIGS. 11B and 15. In some embodiments, the upper guide 182B projects from the divider wall 128 from an upper edge of the opening 180 toward the end 130 of the tank 106. In some embodiments, the upper guide 182B is curved to direct a flow of the fuel 102 moving vertically along the divider wall 128 or the lower guide 182A into the head chamber 126.

In some embodiments, the upper guide 182B is formed by the portion of the divider wall 128 that is cut to form the opening 180. For example, a tab may be cut in the divider wall 128 and bent toward the end wall 130. The tab can then be curved downward to form the upper guide 182B. Alternatively, the upper guide 182B may be a separate component that is attached (e.g., welded, adhered, etc.) to the divider wall 128 adjacent an upper edge of the opening 180.

In some embodiments, a deflector 190 is positioned adjacent the opening 180 on a back side 192 of the divider wall 128 that faces the end wall 132, as best shown in FIGS. 13 and 15. In some embodiments, the deflector is configured to block the fuel 102 from splashing from the head chamber 126 through the opening 180 and into the primary chamber 124. In some embodiments, the deflector projects from the divider wall 128 adjacent an upper edge of the opening 180. In some embodiments, the deflector 190 is curved or bent toward the floor 116 and in front of the opening 180. In some embodiments, the deflector 190 is formed using a tab of the divider wall 128 that was cut to form the opening 180. In some embodiments, the deflector 190 is a separate component that is attached (e.g., welded, adhered, etc.) to the back side 192 of the divider wall 128. In some embodiments, the upper guide 182B and the deflector 190 are formed as an integral component.

Additional embodiments of the invention are directed to methods of supplying a low boiling point fuel to an internal combustion engine 104 of a mobile vehicle 162, such as those using embodiments of the system 100 described above. In some embodiments, the fuel supply system 100 in accordance with one or more of the embodiments described herein are mounted to a mobile vehicle 162, as generally illustrated in FIG. 5. In some embodiments, at least a portion of the primary chamber 124 of the tank volume 108 is filled with fuel 102. The fuel 102 is guided from along the floor 116 of the tank 106 in the primary chamber 124 and into the head chamber 126 through a fluid passageway 160 responsive to movement of the mobile vehicle 162. The fuel 102 in the head chamber 126 is pumped from the head chamber 126 through an output port 112 and to the internal combustion engine 104 of the vehicle 162 using a pump 120 that is external to the tank volume 108, as shown in FIG. 3.

In some embodiments of the method, the fluid pathway 160 comprises a tube 164 having a first end 166 connected to the divider wall 128 adjacent the floor 116 and a second end 168 located within the head chamber 126 at or above the head height 136. The fuel 102 in the primary chamber 124 is guided along the floor 116 of the tank 106 in the primary chamber 124 and into the head chamber 126 by delivering fuel 102 along the floor 116 of the primary chamber through the tube 164 and into the head chamber 126 responsive to movement of mobile vehicle 162, as illustrated, for example, in FIG. 6B. Additional embodiments of the method include method steps in accordance with one or more embodiments discussed above with reference to FIGS. 6-10.

In some embodiments of the method, the fluid pathway 160 comprises a lower guide 182A extending into the primary chamber 124 from the divider wall 128 toward the floor 116 of the tank 106, and an opening 180 in the divider wall 128 that is at or above the head height 136. The fuel 102 in the primary chamber 124 is guided along the floor 116 of the tank 106 in the primary chamber 124 and into the head chamber 126 by directing the fuel 102 in the primary chamber along the lower guide 182A and into the head chamber 126 through the opening 180 responsive to movement of the fuel in the primary chamber, as illustrated, for example, in FIGS. 11B and 15. Additional embodiments of the method include method steps in accordance with one or more embodiments discussed above with reference to FIGS. 11-15.

Although the present invention has been described with reference to preferred embodiments, workers skilled in the art will recognize that changes may be made in form and detail without departing from the spirit and scope of the invention.

What is claimed is:

1. A fuel supply system for supplying a low boiling point fuel to an internal combustion engine of a vehicle comprising:
a fuel tank enclosing a tank volume and comprising:
a primary chamber within the tank volume;
a head chamber within the tank volume configured to contain fuel up to a head height;
a divider wall attached to a wall of the fuel tank, the divider wall separating the primary chamber and the head chamber;
a fluid pathway guides fuel from along a floor of the tank in the primary chamber through the divider wall and into the head chamber at or above the head height, responsive to movement of the fuel in the primary chamber; and
an output port in a wall of the head chamber adjacent the floor.

2. The system according to claim 1, wherein:
the fluid pathway comprises a tube having a first end connected to the divider wall adjacent the floor and a second end located within the head chamber at or above the head height; and
fuel in the primary chamber is delivered through the tube and into the head chamber responsive to movement of fuel in the primary chamber.

3. The system according to claim 2, further comprising a seal between the first end of the tube and the divider wall.

4. The system according to claim 2, wherein:
the fuel tank has an elongated shape and a longitudinal axis; and
the first end of the tube includes an opening that is oriented in the direction of the longitudinal access.

5. The system according to claim 2, wherein:
the fuel tank has an elongated shape and a longitudinal axis; and
the first end of the tube includes an opening that is oriented perpendicularly or transversely to the longitudinal access.

6. The system according to claim 2, wherein the tube includes at least one bend.

7. The system according to claim 1, wherein:
the fluid pathway comprises:
a lower guide extending into the primary chamber from the divider wall toward the floor of the tank; and
an opening in the divider wall that is at or above the head height; and
fuel in the primary chamber is directed along the lower guide and into the head chamber through the opening responsive to movement of the fuel in the primary chamber.

8. The system according to claim 7, wherein the fluid pathway includes an upper guide projecting from the divider wall into the primary chamber adjacent the opening in the divider wall, the upper guide directs fuel through the opening in the divider wall and into the head chamber.

9. The system according to claim 8, wherein the upper guide is curved toward the floor of the tank.

10. The system according to claim 8, further comprising a deflector projecting from the divider wall into the head chamber adjacent the opening in the divider wall.

11. The system according to claim 1, wherein the divider wall extends from the floor of the fuel tank and between opposing sides of the fuel tank.

12. The system according to claim 11, further comprising an opening between the divider wall and a ceiling of the fuel tank.

13. The system according to claim 11, wherein:
the fuel tank includes a first end wall that defines a wall of the primary chamber, and a second end wall that is opposite the first end wall and defines a wall of the head chamber; and
the divider wall is located closer to the second end wall than the first end wall.

14. The system according to claim 1, further comprising a pump located externally to the tank volume and configured to draw fuel from the head chamber through the output port.

15. The system according to claim 14, wherein the fuel supply system does not include a pump within the tank volume.

16. The system according to claim 1, further comprising at least one of return port extending through the wall of the fuel tank and into the head chamber above the head height, and a fill port extending through the wall of the fuel tank and into the head chamber above the head height.

17. A method of supplying a low boiling point fuel to an internal combustion engine of a mobile vehicle comprising:
mounting a fuel tank on the mobile vehicle, the fuel tank enclosing a tank volume and comprising:
a primary chamber within the tank volume;
a head chamber within the tank volume configured to contain fuel up to a head height; and
a divider wall attached to a wall of the fuel tank, the divider wall separating the primary chamber and the head chamber;
guiding fuel from along a floor of the tank in the primary chamber and into the head chamber through a fluid pathway responsive to movement of the mobile vehicle; and
pumping the fuel from the head chamber through an output port and to the internal combustion engine using a pump located externally to the tank volume.

18. The method according to claim 17, wherein:
the fluid pathway comprises a tube having a first end connected to the divider wall adjacent the floor and a second end located within the head chamber at or above the head height; and
guiding fuel from along a floor of the tank in the primary chamber and into the head chamber comprises delivering fuel from along the floor in the primary chamber through the tube and into the head chamber responsive to movement of mobile vehicle.

19. The method according to claim 17, wherein:
the fluid pathway comprises:
a lower guide extending into the primary chamber from the divider wall toward the floor of the tank;
an opening in the divider wall that is at or above the head height; and
guiding fuel from along a floor of the tank in the primary chamber and into the head chamber comprises directing the fuel in the primary chamber along the lower guide and into the head chamber through the opening responsive to movement of the fuel in the primary chamber.

20. The method according to claim 19, wherein:
the fluid pathway comprises an upper guide projecting from the divider wall into the primary chamber adjacent the opening in the divider wall; and
guiding fuel from along a floor of the tank in the primary chamber and into the head chamber comprises directing the fuel in the primary chamber along the lower guide to the upper guide, and along the upper guide and into the head chamber through the opening responsive to movement of the fuel in the primary chamber.
